(19) United States
(12) Patent Application Publication
(10) Pub. No.: US 2020/0056714 A1
(43) Pub. Date: Feb. 20, 2020

(54) DEEP SET PRODUCTION TUBING PRESSURE INSENSITIVE WIRELINE RETRIEVABLE SAFETY VALVE

(71) Applicant: Tejas Research & Engineering, LLC, The Woodlands, TX (US)

(72) Inventors: Jason C. Mailand, The Woodlands, TX (US); Case Nienhuis, Conroe, TX (US); Thomas G. Hill, JR., The Woodlands, TX (US)

(21) Appl. No.: 16/386,624

(22) Filed: Apr. 17, 2019

Related U.S. Application Data
(60) Provisional application No. 62/718,737, filed on Aug. 14, 2018.

(51) Int. Cl. F16K 17/40; E21B 34/16; F16K 17/04; E21B 33/035; E21B 34/14

(52) U.S. Cl. CPC F16K 17/406; E21B 34/16; E21B 2034/005; E21B 33/0355; E21B 34/14; F16K 17/0406

(57) ABSTRACT

A production tubing pressure insensitive wireline retrievable safety valve includes an upper and a lower packing to create a hydraulic seal in an annulus surrounding a portion of the wireline retrievable safety valve and a hydraulic fluid intake port to receive hydraulic fluid in the annulus surrounding the wireline retrievable safety valve within the hydraulic seal from a surface. The hydraulic fluid is communicated to a piston shoulder chamber disposed below the hydraulic seal to move a power piston under actuation pressure and compress a power spring disposed within a gas chamber. A ball valve connected to the power piston moves a ball off seat when the power piston is forced down allowing fluid communication through a plurality of flow ports into a central lumen of the wireline retrievable safety valve exposed when the ball is off seat.

### BACKGROUND OF THE INVENTION

Subsurface safety valves are typically installed during completions as a failsafe mechanism to prevent production flow in the event of an emergency or contingency on the surface. Conventional subsurface safety valves require the application of hydraulic pressure in a control line to open a unidirectional flapper or valve against a power spring influenced by the production tubing pressure at the setting depth. If the hydraulic pressure is removed, the power spring ideally counteracts the hydrostatic head in the control line and fully closes the unidirectional flapper or valve, thereby safely preventing uncontrolled production flow.

Conventional surface-controlled subsurface safety valves include tubing retrievable safety valves and wireline retrievable safety valves. Tubing retrievable safety valves are typically run-in as part of the production tubing string. The control line is disposed in the annulus between the safety valve and the wellbore and provides hydraulic pressure to the safety valve from the surface. The safety valve may be opened by the application of sufficient hydraulic pressure in the control line that forces the unidirectional flapper or valve open against the power spring at the setting depth. If the hydraulic pressure is removed, the power spring ideally counteracts the hydrostatic head in the control line and fully closes the unidirectional flapper or valve. While tubing retrievable safety valves must be run-in with the production tubing, they typically provide the largest inner diameter for production flow. In contrast, wireline retrievable safety valves may be run-in with a wireline or slickline. However, wireline retrievable safety valves must be landed in a profile or hydraulic landing nipple disposed within the production tubing. As such, wireline retrievable safety valves typically have a smaller inner diameter that restricts production flow as compared to tubing retrievable safety valves.

Offshore drilling and production in deep and ultra-deep waters has received renewed interest from operators. According to the International Energy Agency, a substantial portion of the remaining recoverable conventional oil and gas reserves lie below the seafloor in deep or ultra-deep waters where production is conducted in water depths between 5,000 and 12,000 feet or more. The wellbore may have a measured depth a further 10,000 feet or more below the seafloor. At depth, the downhole temperature may exceed 400° F. and the formation pressure may exceed 25,000 pounds per square inch (“PSI”). As such, the pressures encountered at deep and ultra-deep water depths present a number of challenges for subsurface safety valves.

### BRIEF SUMMARY OF THE INVENTION

According to one aspect of one or more embodiments of the present invention, a production tubing pressure insensitive wireline retrievable safety valve includes a locking mechanism to secure the wireline retrievable safety valve within a tubing retrievable safety valve, or within a hydraulic landing nipple. An upper packing and a lower packing create a hydraulic seal in an annulus surrounding a portion of the wireline retrievable safety valve. A hydraulic fluid intake port receives hydraulic fluid in the annulus surrounding the wireline retrievable safety valve within the hydraulic seal from the surface. The hydraulic fluid is communicated via at least one hydraulic fluid passage to a piston shoulder chamber disposed below the hydraulic seal to move a power piston under actuation pressure and compress a power spring disposed within a gas chamber. A ball valve disposed above the hydraulic chamber and connected to the power piston moves a ball off seat when the power piston is forced down. At least one flow port that allows fluid communication from the annulus surrounding a portion of the wireline retrievable safety valve below the hydraulic seal into a central lumen of the wireline retrievable safety valve exposed when the ball is moved off seat.

According to one aspect of one or more embodiments of the present invention, a production tubing pressure insensitive wireline retrievable safety valve includes a locking mechanism to secure the wireline retrievable safety valve within a tubing retrievable safety valve, or within a hydraulic landing nipple. An upper packing creates an upper hydraulic seal on an annulus between the wireline retrievable safety valve and the tubing retrievable safety valve above a hydraulic fluid intake port. A spacer disposes the hydraulic fluid intake port below a primary valve of the tubing retrievable safety valve. A lower packing creates a lower hydraulic seal on the annulus between the wireline retrievable safety valve and the tubing retrievable safety valve, or hydraulic landing nipple, below the hydraulic fluid intake port and the primary valve of the tubing retrievable safety valve, or within the hydraulic landing nipple. The upper hydraulic seal and the lower hydraulic seal form a hydraulic seal. A lower packing housing includes a first hydraulic fluid passage in fluid communication with the hydraulic fluid intake port and a production tubing pressure insensitive valve assembly. The valve assembly includes a seat housing having a second hydraulic fluid passage in fluid communication with the first hydraulic fluid passage and at least one flow port. A spring housing has a diameter smaller than the seat housing. A hydraulic chamber housing includes a third hydraulic fluid passage in fluid communication with the second hydraulic fluid passage. The third hydraulic fluid passage is in fluid communication with a piston shoulder chamber. The hydraulic chamber housing connects the seat housing to the spring housing. A hard seat is disposed near a distal end of the lower packing housing within the seat housing. A soft seat is disposed near a distal end of the hard seat. A ball is disposed near a distal end of the soft seat. A power piston is connected on a first distal end to the ball and on a second distal end to a nose cap housing. The power piston extends through the hydraulic chamber housing. An upper power seal seals an annulus surrounding the power piston and an upper portion of the hydraulic chamber housing. An upper power seal retainer retains the upper power seal in place. An intermediate power seal seals an annulus surrounding the power piston and a lower portion of the hydraulic chamber housing. The intermediate power seal has a diameter smaller than the upper power seal and a lower power seal. An intermediate power seal retainer retains the intermediate power seal in place. A spring ring is disposed on a top distal end of a power spring disposed within the spring housing. A nose cap housing is connected to a bottom distal end of the spring housing. The lower power seal seals an annulus surrounding the power piston and an upper portion of the nose cap housing. A lower power seal retainer retains the lower power seal in place.

According to one aspect of one or more embodiments of the present invention, a method of providing a deep set production tubing pressure insensitive wireline retrievable safety valve in a failed tubing retrievable safety valve includes running a communication tool into the tubing retrievable safety valve, communicating the tubing retrievable safety valve, landing a production tubing pressure insensitive wireline retrievable safety valve within a no-go shoulder profile of the tubing retrievable safety valve, locking the wireline retrievable safety valve to the tubing retrievable safety valve, and controlling an actuation pressure of the production tubing pressure insensitive wireline retrievable safety valve from the surface.

Other aspects of the present invention will be apparent from the following description and claims.

### BRIEF DESCRIPTION OF THE DRAWINGS

FIG. 1A shows a half section view of a tubing retrievable safety valve in accordance with one or more embodiments of the present invention.

FIG. 1B shows a half section view of a tubing retrievable safety valve with a deep set production tubing pressure insensitive wireline retrievable safety valve partially disposed therein in accordance with one or more embodiments of the present invention.

FIG. 2A shows a bottom facing perspective view of a portion of a deep set production tubing pressure insensitive wireline retrievable safety valve in accordance with one or more embodiments of the present invention.

FIG. 2B shows a bottom facing exploded view of a portion of a deep set production tubing pressure insensitive wireline retrievable safety valve in accordance with one or more embodiments of the present invention.

FIG. 3A shows a cross section view of a portion of a deep set production tubing pressure insensitive wireline retrievable safety valve in accordance with one or more embodiments of the present invention.

FIG. 3B shows a cross section view of a portion of a deep set production tubing pressure insensitive wireline retrievable safety valve disposed within a tubing retrievable safety valve with a ball valve in a closed state preventing flow in accordance with one or more embodiments of the present invention.

FIG. 3C shows a cross section view of a portion of a deep set production tubing pressure insensitive wireline retrievable safety valve disposed within a tubing retrievable safety valve with a ball valve in an opened state permitting flow in accordance with one or more embodiments of the present invention.

FIG. 3D shows a detailed portion of a cross section view of a portion of the deep set production tubing pressure insensitive wireline retrievable safety valve disposed within the tubing retrievable safety valve with the ball valve in an opened state permitting flow in accordance with one or more embodiments of the present invention.

FIG. 4A shows a detailed portion of a perspective view of a ball valve of a deep set production tubing pressure insensitive wireline retrievable safety valve on seat in accordance with one or more embodiments of the present invention.

FIG. 4B shows a detailed portion of a perspective view of ball valve of a deep set production tubing pressure insensitive wireline retrievable safety valve off seat under actuation pressure in accordance with one or more embodiments of the present invention.

### DETAILED DESCRIPTION OF THE INVENTION

One or more embodiments of the present invention are described in detail with reference to the accompanying figures. For consistency, like elements in the various figures are denoted by like reference numerals. In the following detailed description of the present invention, specific details are set forth in order to provide a thorough understanding of the present invention. In other instances, well-known features to one of ordinary skill in the art are not described to avoid obscuring the description of the present invention.

In deep and ultra-deep water applications, tubing retrievable safety valves have a depth setting limitation due to the high hydrostatic head pressure in the control line that increases with depth. If the setting depth and hydrostatic head in the control line is excessive, the power spring within the tubing retrievable safety valve will not be able to sufficiently lift the hydraulic fluid in the control line (uncompress the power spring) to allow the valve to fully close. In an attempt to address this serious limitation, some tubing retrievable safety valves include a nitrogen charged chamber that offsets the hydrostatic head pressure. However, nitrogen charged tubing retrievable safety valves are expensive and, due to their complex design, do not include redundancy. To date, the industry has not had success in designing a wireline retrievable safety valve that reliably works at the required setting depths for the same reasons. In addition, the elevated actuation pressure required due to the production tubing pressure at the required setting depths has proven problematic. As such, the failure of a tubing retrievable safety valve in deep or ultra-deep water applications is a significant, if not catastrophic, event. However, in the field, such failures are frequently occurring at substantial cost to ongoing operations.

Production tubing pressure variations, including directional pressure reversals across sealing elements, have caused various sealing elements within the tubing retrievable safety valve to fail, resulting in the loss of nitrogen that ultimately reduces or eliminates the ability of the power spring of the safety valve to fully close at extended setting depths. Because nitrogen charged tubing retrievable safety valves do not include redundancy, when the safety valve fails, there is no viable option to continue production operations. Production operations must be ceased and the production tubing string must be pulled at substantial expense, including non-productive time, to repair or replace the failed tubing retrievable safety valve. In addition, once the production tubing retrievable safety valve fails, there are significant safety and environmental risks as well. As such, there is a long felt, but unsolved need in the industry for a wireline retrievable safety valve capable of deployment within a failed tubing retrievable safety valve at extended setting depths encountered in deep and ultra-deep water applications.

Accordingly, in one or more embodiments of the present invention, a deep set production tubing pressure insensitive wireline retrievable safety valve provides a wireline solution that does not require nitrogen assisted lift that allows for controlled production flow through a failed tubing retrievable safety valve disposed at extended setting depths encountered in deep or ultra-deep water applications. The wireline retrievable safety valve may be landed within a no-go shoulder or internal landing profile of the failed tubing retrievable safety valve and controllably open or close in a manner that is not sensitive to production tubing pressure. The safety valve may include a power spring disposed within a gas chamber below a ball valve that is not exposed to production tubing pressure and does not require nitrogen to uncompress. An upper power seal and a lower power seal may be disposed on opposing distal ends of a power piston and have the same diameter, thereby canceling out production tubing pressure forces acting on the power piston. As such, the wireline retrievable safety valve allows for an actuation pressure that is substantially lower than the production tubing pressure and ensures full closure of the ball valve when the actuation pressure is removed. In addition, the seals are not exposed to pressure reversals and the reliability of the valve mechanism is increased.

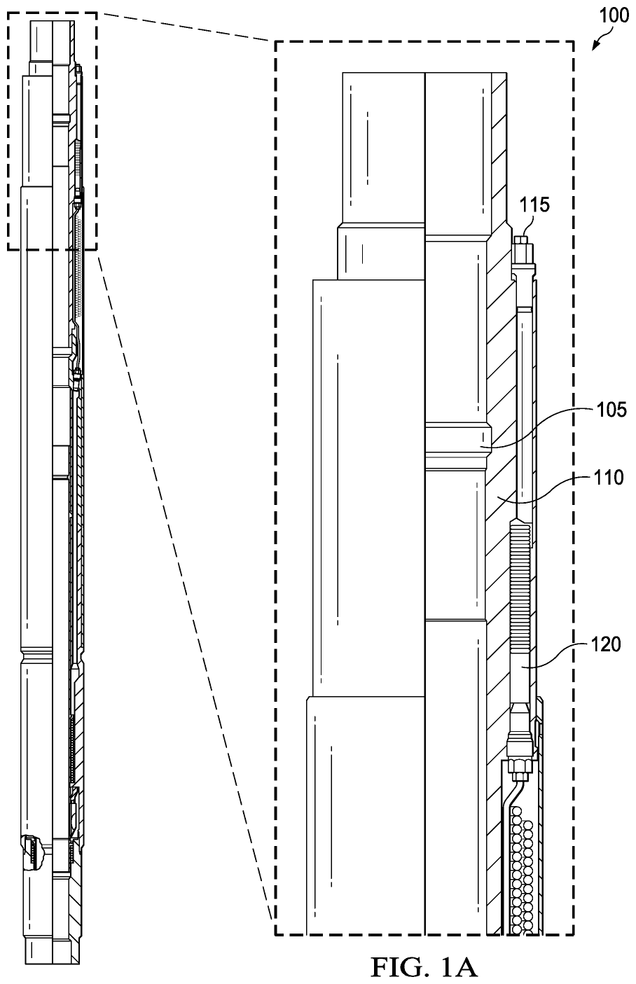

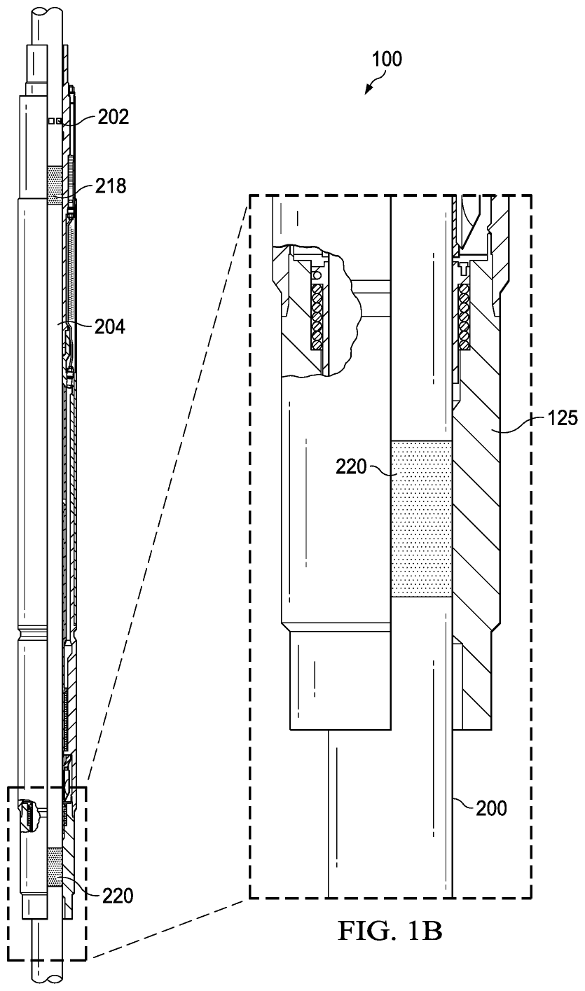

FIG. 1A shows a half section view of a tubing retrievable safety valve 100 in accordance with one or more embodiments of the present invention. A deep set tubing retrievable safety valve 100 may be run-in as part of a production tubing string (not shown) in, for example, a deep or ultra-deep water application and used as a failsafe mechanism to prevent uncontrolled production flow towards the surface (not shown). A control line (not shown) may be provided in the annulus between the tubing retrievable safety valve 100 and the wellbore (not shown) and connect to a hydraulic fluid injection port 115 that provides hydraulic fluid (not shown) to the valve actuation mechanism (not independently illustrated). In the event the tubing retrievable safety valve 100 fails, for example, a nitrogen failure that prevents the valve from fully closing, a deep set production tubing pressure insensitive wireline retrievable safety valve (not shown) may be partially disposed within a central lumen of the failed tubing retrievable safety valve 100.

Prior to deployment of a deep set production tubing pressure insensitive wireline retrievable safety valve (not shown), the failed tubing retrievable safety valve 100 must be punctured for hydraulic fluid communication and the valve mechanism must be locked open. A puncture communication tool (not shown) may be run-in to the failed tubing retrievable safety valve 100 to puncture the sidewall of the safety valve 100 and the hydraulic fluid conduit 120 below a no-go shoulder or internal landing profile 105 and an upper polished bore 110 of the safety valve 100. The puncture allows communication of hydraulic fluid (not shown) between the floating rig or platform on the surface of the body of water (not shown) and the central lumen (not shown) of the tubing retrievable safety valve 100, by way of hydraulic fluid injection port 115. Once communicated, a lock-open tool (not shown) may be run-in to the failed tubing retrievable safety valve 100 to push down the flow tube (not shown) and compress the power spring (not shown) such that the primary flapper or valve (not shown) remains in a locked open position rendering the failed tubing retrievable safety valve 100 inoperable as a safety valve by itself.

Continuing, FIG. 1B shows a half section view of a tubing retrievable safety valve 100 with a deep set production tubing pressure insensitive wireline retrievable safety valve 200 partially disposed therein in accordance with one or more embodiments of the present invention. A deep set production tubing pressure insensitive wireline retrievable safety valve 200 may be landed within a no-go shoulder or internal landing profile (e.g., 105 of FIG. 1A) of the failed tubing retrievable safety valve 100. A locking mechanism, such as, for example, a plurality of locking dogs 202 may lock or secure the wireline retrievable safety valve 200 to the tubing retrievable safety valve 100. One of ordinary skill in the art will recognize that other locking mechanisms may be used in accordance with one or more embodiments of the present invention. An upper packing element 218 may interface with the upper polished bore (e.g., 110 of FIG. 1A) and create an upper hydraulic seal in the annulus between the wireline retrievable safety valve 200 and the tubing retrievable safety valve 100. A spacer 204, which may vary in length based on an application or design, may be used to dispose a lower packing element 220 below the flapper or valve (not shown) mechanism of the tubing retrievable safety valve 100. The lower packing element 220 may interface with lower polished bore 125 and create a lower hydraulic seal in the annulus between the wireline retrievable safety valve 200 and the tubing retrievable safety valve 100. The upper packing element 218 and the lower packing element 220 may create a hydraulic seal that allows hydraulic fluid (not shown) to be communicated from the surface (not shown) into a hydraulic fluid intake port (not independently shown) of the wireline retrievable safety valve 200 disposed within the hydraulic seal. An actuation pressure may be applied to the hydraulic fluid intake port (not independently shown) to move a ball valve (not shown) off seat (not shown) in a manner that is not sensitive to production tubing pressure.

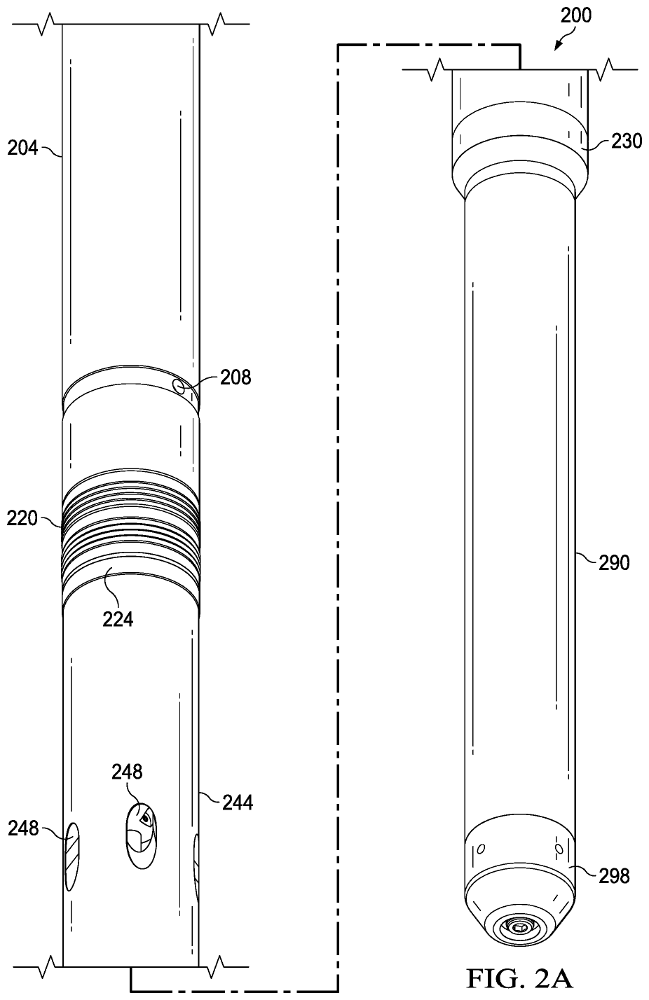

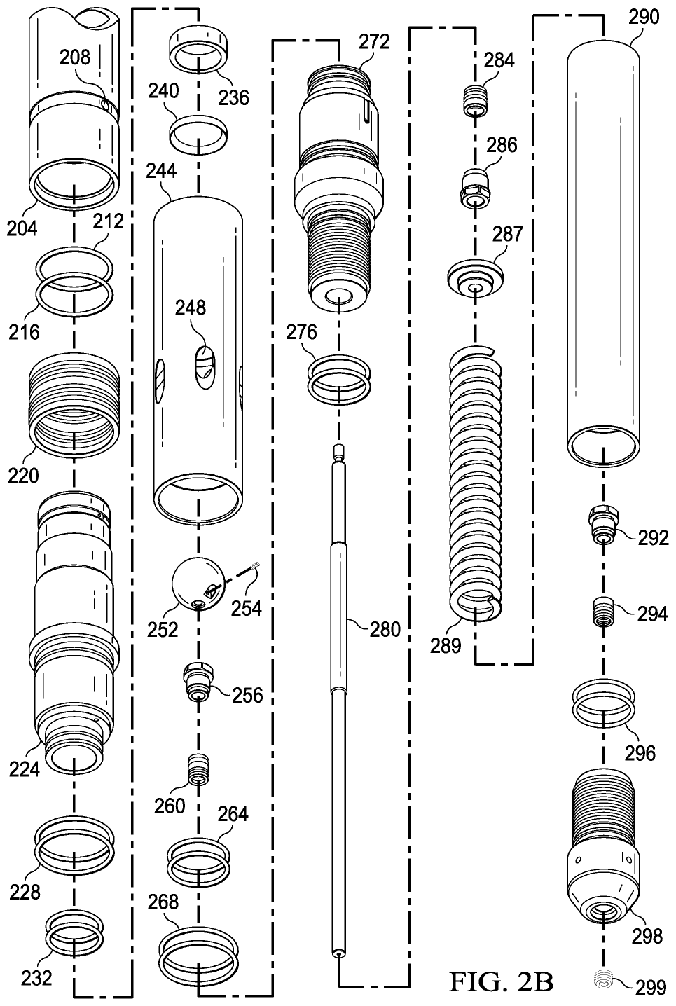

FIG. 2A shows a bottom facing perspective view of a portion of a deep set production tubing pressure insensitive wireline retrievable safety valve 200 in accordance with one or more embodiments of the present invention. In one or more embodiments of the present invention, a deep set production tubing pressure insensitive wireline retrievable safety valve 200 may include a locking mechanism (not shown) to secure the wireline retrievable safety valve 200 within an inner diameter of a tubing retrievable safety valve 100, an upper packing housing (not shown), an upper packing element (not shown) that may create an upper hydraulic seal on an annulus between the wireline retrievable safety valve 200 above a hydraulic fluid intake port 208, and a spacer 204. One of ordinary skill in the art will recognize that the upper packing housing (not shown) and the upper packing element (not shown) may be substantially similar to that of lower packing housing 224 and lower packing element 220 described in more detail herein. Spacer 204 may include the hydraulic fluid intake port 208 that connects an exterior of spacer 204 to a central lumen, or passageway, disposed therein and have a length to dispose the hydraulic fluid intake port 208 below a flapper or valve (not shown) of the tubing retrievable safety valve 100 in which the wireline retrievable safety valve 200 is disposed. The hydraulic fluid intake port 208 receives surface-injected hydraulic fluid (not shown) from the annulus surrounding the safety valve 200 when deployed within the failed safety valve (e.g., 100 of FIG. 1). Safety valve 200 may also include the lower packing element 220 to create a lower hydraulic seal on the annulus between the wireline retrievable safety valve 200 and the tubing retrievable safety valve 100 below the hydraulic fluid intake port 208 and the flapper or valve (not shown) of the tubing retrievable safety valve 100, a lower packing housing 224, a seat housing 244, a plurality of flow ports 248 disposed about the seat housing 244, a hydraulic chamber housing 230, a spring housing 290, and a nose cap 298.

Continuing, FIG. 2B shows a bottom facing exploded view of a portion of a deep set production tubing pressure insensitive wireline retrievable safety valve 200 in accordance with one or more embodiments of the present invention. In one or more embodiments of the present invention, wireline retrievable safety valve 200 may include a spacer 204 having a hydraulic fluid intake port 208 and a plurality of O-rings 212 and 216 that seal the connection between a lower packing housing 224 and spacer 204. A lower packing element 220 covers a portion of lower packing housing 224 and a plurality of double O-rings 228 and 232 seal the connection interface between the lower packing housing 224 and seat housing 244. A hard seat 236 and a soft seat 240 partially receive a ball 252. Seat housing 244 may include a plurality of flow ports 248. One or more setting screws 254 may be disposed within ball 252. The wireline retrievable safety valve 200 may also include an upper retention screw 256, an upper power seal 260, a plurality of double O-rings 264 and 268 that seal the connection interface between hydraulic chamber housing 272 and seat housing 244, a double O-ring 276 that seals the connection interface between hydraulic chamber housing 272 and spring housing 290, a power piston 280, an intermediate power seal 284, an intermediate retention screw 286, a spring ring 287, a power spring 289, a lower retention screw 292, a lower power seal 294, a double O-ring 296 that seals the connection interface between spring housing 290 and nose cap housing 298, and a nose cap plug 299, discussed in more detail herein.

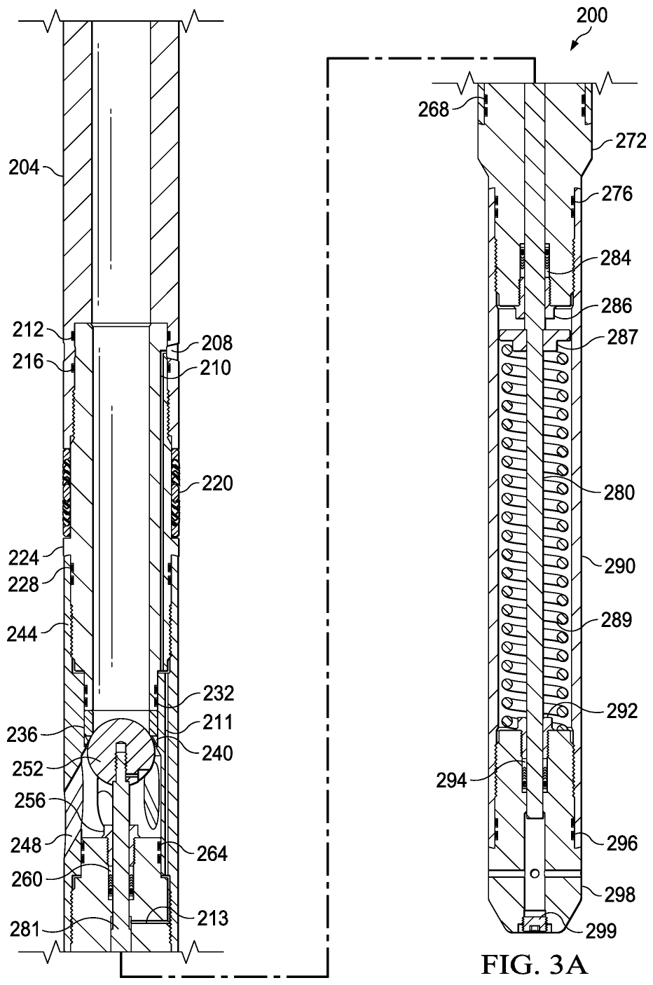

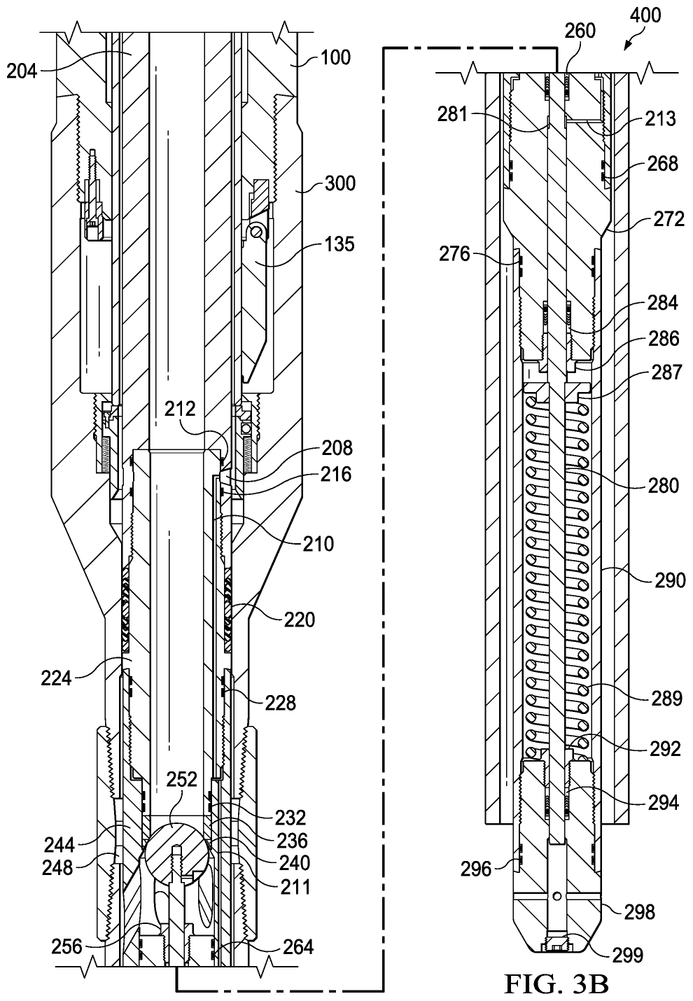

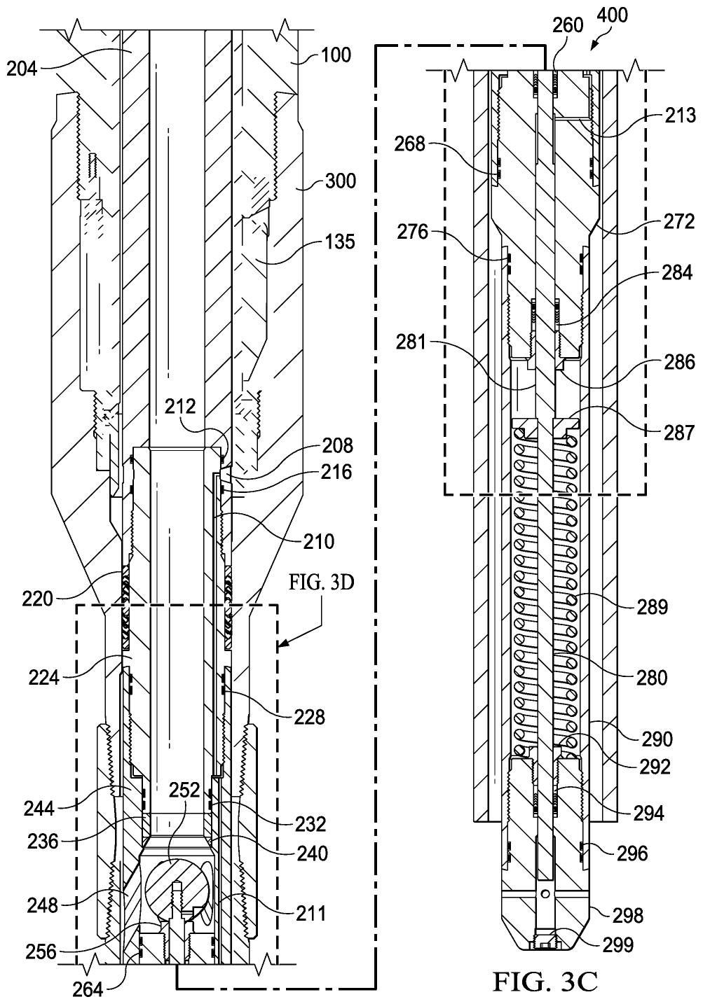

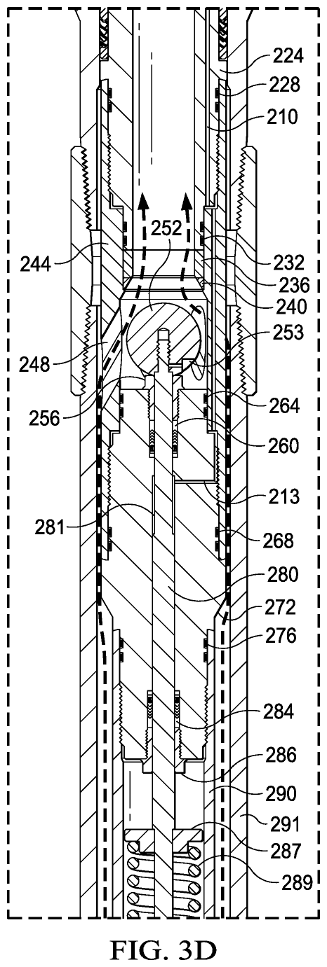

FIG. 3A shows a cross section view of a portion of a deep set production tubing pressure insensitive wireline retrievable safety valve 200 in accordance with one or more embodiments of the present invention. Spacer 204 may include a central lumen through which formation fluids (not shown) may flow when the ball 252 valve is moved off soft seat 240. A lower packing housing 225 may connect to spacer 204 and may include a first hydraulic fluid passage 210 to align with hydraulic fluid intake port 208 of spacer 204. When hydraulic fluid (not shown) is injected from the surface (not shown), hydraulic fluid (not shown) may flow into the hydraulic fluid intake port 208, through first hydraulic fluid passage 210 that traverses the hydraulic seal formed by the upper packing element (not shown) and the lower packing element 220 into a second hydraulic fluid passage 211 and a third hydraulic fluid passage 213. If sufficient actuation pressure is provided, the hydraulic fluid exerts a downward force on a piston shoulder chamber 281 that causes power piston 280 to move down and compress power spring 289, thereby moving ball 252 off soft seat 240 (not shown).

Continuing, FIG. 3B shows a cross section view of a portion of a deep set production tubing pressure insensitive wireline retrievable safety valve 200 disposed within a tubing retrievable safety valve 100 with a ball 252 valve in a closed state preventing flow in accordance with one or more embodiments of the present invention. In one or more embodiments of the present invention, wireline retrievable safety valve 200 may be landed within a no-go shoulder profile of the tubing retrievable safety valve 100 (which is punctured and locked open prior to landing). A locking mechanism (not shown) may be used to secure wireline retrievable safety valve 200 to tubing retrievable safety valve 100. An upper packing (not shown) and lower packing 220 may create a hydraulic seal in an annulus surrounding a portion of the wireline retrievable safety valve 200. A hydraulic fluid intake port 208 may receive hydraulic fluid in the annulus surrounding the wireline retrievable safety valve 200 within the hydraulic seal from a floating rig or platform (not shown) disposed on a surface (not shown) of a body of water (not shown). The hydraulic fluid (not shown) may be communicated via first hydraulic fluid passage 210, second hydraulic fluid passage 211, and third hydraulic fluid passage 213 disposed below the hydraulic seal to a piston shoulder chamber 281 and, if sufficient actuation pressure is provided, may exert a downward force on piston shoulder chamber 281 that causes power piston 280 to move down and compress a power spring 289 disposed within an a gas chamber. A ball 252 valve may be disposed above the hydraulic chamber and may be connected to the power piston 280. Absent sufficient actuation pressure, power spring 289 uncompresses and ball 252 is moved fully on soft seat 240 and hard seat 236, thereby preventing formation fluids (not shown) from flowing toward the surface (not shown) through safety valve 200.

Power spring 289 may be disposed within a gas chamber formed by spring housing 290, intermediate power seal 284, hydraulic chamber housing 272, lower power seal 284, and nose cap housing 298. The gas chamber may be voided, filled with air, or charged with one or more gases, including potentially, nitrogen, although nitrogen charging is not required to uncompress power spring 289 at deep or ultra-deep water setting depths. While upper power seal 260 and lower power seal 294 are in communication with production tubing pressure, both seals have the same diameter and are disposed on opposing ends of power piston 280. As such, their pressure areas are the same and the forces acting on the power piston 280 effectively cancel each other out. As such, power spring 289 may not be exposed, or sensitive, to production tubing pressure. Thus, the actuation pressure required to compress power spring 289 may be substantially less than the production tubing pressure and when that actuation pressure is removed, power spring 289 does not require nitrogen charging to uncompress and fully close the valve 200 at a deep or ultra-deep water application setting depth.

Continuing, FIG. 3C shows a cross section view of a portion of a deep set production tubing pressure insensitive wireline retrievable safety valve 200 disposed within a tubing retrievable safety valve 100 with a ball 252 valve in an opened state permitting flow in accordance with one or more embodiments of the present invention. As previously discussed, tubing retrievable safety valve 100 has been punctured (not shown) and flapper 135 is locked open. Wireline retrievable safety valve 200 has been landed within a no-go shoulder or internal landing profile (not shown) of tubing retrievable safety valve 100 and locked (not shown) or otherwise secured to tubing retrievable safety valve 100. An upper packing (not shown) element forms an upper hydraulic seal in the annulus between wireline retrievable safety valve 200 and tubing retrievable safety valve 100. Lower packing element 220 forms a lower hydraulic seal in the annulus between wireline retrievable safety valve 200 and tubing retrievable safety valve 100. The upper and lower hydraulic seals form a hydraulic seal. Hydraulic fluid (not shown) may be injected from the surface (not shown) via the puncture (not shown) into the annulus surrounding the wireline retrievable safety valve 200 disposed between the upper and lower hydraulic seals. The injected hydraulic fluid (not shown) in the annulus enters the hydraulic fluid intake port 208 and flows through first hydraulic fluid passage 210, second hydraulic fluid passage 211, and third hydraulic fluid passage 213 to a piston shoulder chamber 281.

Continuing, FIG. 3D shows a detailed portion of a cross section view of a portion of a deep set production tubing pressure insensitive wireline retrievable safety valve 200 disposed within a tubing retrievable safety valve 100 with a ball 252 valve in an opened state permitting flow in accordance with one or more embodiments of the present invention. As shown in the detailed view, power piston 280 may be connected on a first distal end to ball 252 by one or more set screws 253 and on a second distal end to a nose cap housing (e.g., 298 of FIG. 3C). Power piston 280 may extend through hydraulic chamber housing 272. Spring ring 287 may be disposed on a top distal end of power spring 289. Upper power seal 260 may seal an annulus surrounding power piston 280 and an upper portion of hydraulic chamber housing 272. Upper power seal retainer 256 may retain upper power seal 260 in place. Intermediate power seal 284 may seal an annulus surrounding power piston 280 and a lower portion of hydraulic chamber housing 272. Intermediate power seal retainer 286 may retain intermediate power seal 284 in place. As such, any pressure trapped between upper power seal 260 and intermediate power seal 284 forces power piston 280 down. If the hydraulic fluid (not shown) is provided at the actuation pressure or higher, hydraulic fluid enters third hydraulic fluid passage 213 and piston shoulder chamber 281, forcing power piston 280 down, compressing power spring 289, and moving ball 252 off soft seat 240 and hard seat 236. When ball 252 is off soft seat 240, formation fluids in the annulus between spring housing 290 and production tubing 291 enter wireline retrievable safety valve 200. A plurality of flow ports 248 may allow fluid communication from the annulus surrounding the wireline retrievable safety valve 200 below the hydraulic seal into a central lumen of the wireline retrievable safety valve 200 that is exposed when ball 252 is moved off soft seat 240.

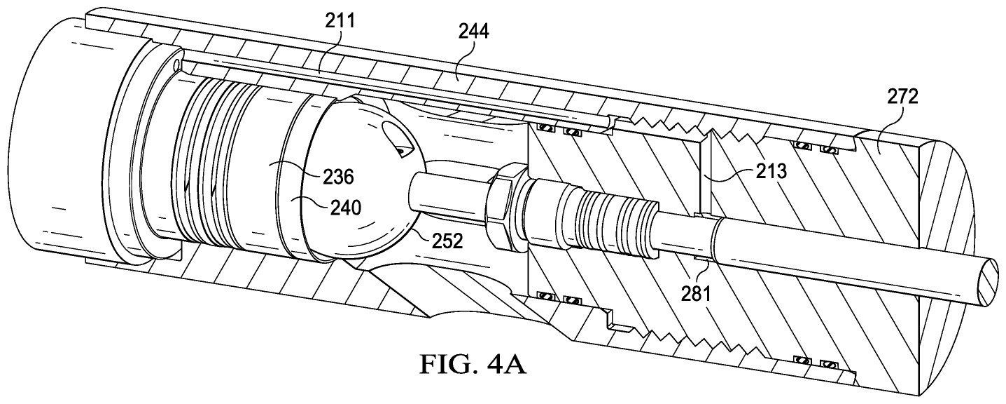

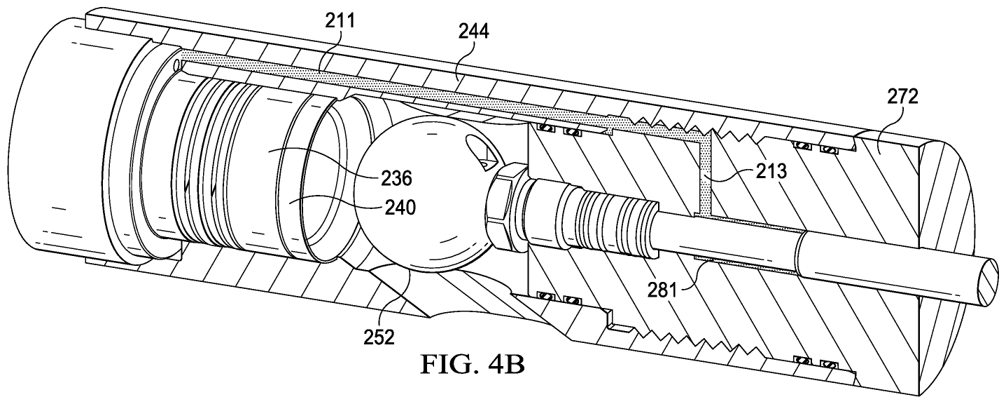

FIG. 4A shows a detailed portion of a perspective view of a ball 252 valve of a deep set production tubing pressure insensitive wireline retrievable safety valve 200 on seat 240 in accordance with one or more embodiments of the present invention. Absent sufficient actuation pressure, first hydraulic fluid passage (not shown), second hydraulic fluid passage 211, third hydraulic fluid passage 213, and piston shoulder chamber 281 may be voided.

Continuing, FIG. 4B shows a detailed portion of a perspective view of a ball 252 valve of a deep set production tubing pressure insensitive wireline retrievable safety valve 200 off seat 240 under actuation pressure in accordance with one or more embodiments of the present invention. When sufficient actuation pressure is applied, hydraulic fluid may be injected from the surface (not shown) into a hydraulic fluid intake port (not shown) and communicated via a first hydraulic fluid passage (not shown) disposed within the lower packing housing (not shown) to second hydraulic fluid passage 211 disposed within seat housing 244. Second hydraulic fluid passage 211 may communicate hydraulic fluid to third hydraulic fluid passage 213 of hydraulic chamber housing 272. Third hydraulic fluid passage 213 may communicate hydraulic fluid to piston shoulder chamber 281.

Advantages of one or more embodiments of the present invention may include one or more of the following:

In one or more embodiments of the present invention, a deep set production tubing pressure insensitive wireline retrievable safety valve provides a wireline solution that allows for controlled production flow through a failed tubing retrievable safety valve disposed in deep or ultra-deep water applications that typically requires removal of the production tubing string.

In one or more embodiments of the present invention, a deep set production tubing pressure insensitive wireline retrievable safety valve may be landed within a no-go shoulder profile of a failed tubing retrievable safety valve deployed in a deep or ultra-deep water wellbore.

In one or more embodiments of the present invention, a deep set production tubing pressure insensitive wireline retrievable safety valve is production tubing pressure insensitive. The safety valve may be controllably opened or closed in deep or ultra-deep water applications in a manner that is independent of the production tubing pressure.

In one or more embodiments of the present invention, a deep set production tubing pressure insensitive wireline retrievable safety valve provides an actuation pressure that is substantially lower than the production tubing pressure at a setting depth of the wireline retrievable safety valve.

In one or more embodiments of the present invention, a deep set production tubing pressure insensitive wireline retrievable safety valve includes seals that are not exposed to pressure reversals and increases reliability of the seals and the safety valve.

In one or more embodiments of the present invention, a deep set production tubing pressure insensitive wireline retrievable safety valve includes an upper power seal and a lower power seal that are exposed to production tubing pressure on opposing ends of the power piston that cancel each other out.

In one or more embodiments of the present invention, a deep set production tubing pressure insensitive wireline retrievable safety valve includes a power spring disposed within a gas chamber below the ball valve that is not exposed to production tubing pressure.

In one or more embodiments of the present invention, a deep set production tubing pressure insensitive wireline retrievable safety valve includes a power spring disposed within a gas chamber below the ball valve that is not sensitive to production tubing pressure.

In one or more embodiments of the present invention, a deep set production tubing pressure insensitive wireline retrievable safety valve includes a power spring disposed within a gas chamber below the ball valve that does not require nitrogen charging to uncompress at a setting depth, but the gas chamber may be voided, filled with air, or charged with one or more gases, potentially including nitrogen.

In one or more embodiments of the present invention, a deep set production tubing pressure insensitive wireline retrievable safety valve includes an upper power seal and a lower power seal that seal an annulus surrounding the power piston and are exposed to production tubing pressure.

In one or more embodiments of the present invention, a deep set production tubing pressure insensitive wireline retrievable safety valve include an upper power seal and a lower power seal that have the same diameter to cancel out production tubing pressure forces acting on opposing ends of the power piston.

In one or more embodiments of the present invention, a deep set production tubing pressure insensitive wireline retrievable safety valve includes an upper power seal, an intermediate power seal, and a lower power seal that are not exposed to pressure reversals and therefore increases reliability.

While the present invention has been described with respect to the above-noted embodiments, those skilled in the art, having the benefit of this disclosure, will recognize that other embodiments may be devised that are within the scope of the invention as disclosed herein. Accordingly, the scope of the invention should be limited only by the appended claims.

What is claimed is:

1. A production tubing pressure insensitive wireline retrievable safety valve comprising:
a locking mechanism to secure the wireline retrievable safety valve within a tubing retrievable safety valve, or hydraulic communication nipple;
an upper packing and a lower packing to create a hydraulic seal in an annulus surrounding a portion of the wireline retrievable safety valve;
a hydraulic fluid intake port to receive hydraulic fluid in the annulus surrounding the wireline retrievable safety valve within the hydraulic seal from the surface, wherein the hydraulic fluid is communicated via at least one hydraulic fluid passage to a piston chamber disposed below the hydraulic seal to move a power piston down under actuation pressure and compress a power spring disposed within a gas chamber;
a ball valve disposed above the hydraulic chamber and connected to the power piston that moves a ball off seat when the power piston is forced down; and
at least one flow port that allow fluid communication from an annulus surrounding a portion of the wireline retrievable safety valve below the hydraulic seal into a central lumen of the wireline retrievable safety valve exposed when the ball is off seat.

2. The production tubing pressure insensitive wireline retrievable safety valve of claim 1, wherein the actuation pressure is not sensitive to production tubing pressure.

3. The production tubing pressure insensitive wireline retrievable safety valve of claim 1, wherein the actuation pressure is substantially lower than a production tubing pressure at a setting depth of the wireline retrievable safety valve.

4. The production tubing pressure insensitive wireline retrievable safety valve of claim 1, wherein the power spring disposed within the gas chamber is not exposed to production tubing pressure.

5. The production tubing pressure insensitive wireline retrievable safety valve of claim 1, wherein the power spring disposed within the gas chamber is not sensitive to production tubing pressure.

6. The production tubing pressure insensitive wireline retrievable safety valve of claim 1, wherein the power spring disposed within the gas chamber does not require nitrogen charging to uncompress at a setting depth.

7. The production tubing pressure insensitive wireline retrievable safety valve of claim 1, wherein an upper power seal and a lower power seal seals an annulus surrounding the power piston and are exposed to production tubing pressure.

8. The production tubing pressure insensitive wireline retrievable safety valve of claim 1, wherein an upper power seal and a lower power seal have a same diameter to cancel out production tubing pressure forces acting on the power piston.

9. The production tubing pressure insensitive wireline retrievable safety valve of claim 1, wherein an upper power seal, an intermediate power seal, and a lower power seal are not exposed to pressure reversals.

10. A production tubing pressure insensitive wireline retrievable safety valve comprising:
a locking mechanism to secure the wireline retrievable safety valve within
a tubing retrievable safety valve;
an upper packing to create an upper hydraulic seal on an annulus between the wireline retrievable safety valve and the tubing retrievable safety valve above a hydraulic fluid intake port;
a spacer comprising the hydraulic fluid intake port, wherein the spacer disposes the hydraulic fluid intake port below a primary valve of the tubing retrievable safety valve;
a lower packing to create a lower hydraulic seal on the annulus between the wireline retrievable safety valve and the tubing retrievable safety valve below the hydraulic fluid intake port and the primary valve of the tubing retrievable safety valve, wherein the upper hydraulic seal and the lower hydraulic seal form a hydraulic seal;
a lower packing housing comprising a first hydraulic fluid passage in fluid communication with the hydraulic fluid intake port;
a production tubing pressure insensitive valve assembly comprising:
a seat housing comprising a second hydraulic fluid passage in fluid communication with the first hydraulic fluid passage and a plurality of flow ports,
a spring housing having a diameter smaller than the seat housing,
a hydraulic chamber housing comprising a third hydraulic fluid passage in fluid communication with the second hydraulic fluid passage, wherein the third hydraulic fluid passage is in fluid communication with a piston shoulder chamber and wherein the hydraulic chamber housing connects the seat housing to the spring housing,
a hard seat disposed near a distal end of the lower packing housing within the seat housing,
a soft seat disposed near a distal end of the hard seat,
a ball disposed near a distal end of the soft seat,
a power piston connected on a first distal end to the ball and on a second distal end to a nose cap housing, wherein the power piston extends through the hydraulic chamber housing,
an upper power seal that seals an annulus surrounding the power piston and an upper portion of the hydraulic chamber housing,
an upper power seal retainer to retain the upper power seal in place,
an intermediate power seal that seals an annulus surrounding the power piston and a lower portion of the hydraulic chamber housing, wherein the intermediate power seal has a diameter smaller than the upper power seal and a lower power seal,
an intermediate power seal retainer to retain the intermediate power seal in place,
a spring ring disposed on a top distal end of a power spring disposed within the spring housing,
a nose cap housing connected to a bottom distal end of the spring housing,
the lower power seal seals an annulus surrounding the power piston and an upper portion of the nose cap housing, and
a lower power seal retainer to retain the lower power seal in place.

11. The production tubing pressure insensitive wireline retrievable safety valve of claim 10, wherein the surface provides a hydraulic fluid to the hydraulic fluid intake port within the hydraulic seal that is communicated via the first and second hydraulic fluid passages to the piston shoulder chamber disposed below the lower hydraulic seal to move the power piston and compress the power spring disposed within a gas chamber under actuation pressure.

12. The production tubing pressure insensitive wireline retrievable safety valve of claim 10, wherein at least one flow port allow fluid communication from an annulus surrounding a portion of the wireline retrievable safety valve below the lower hydraulic seal into a central lumen of the wireline retrievable safety valve exposed when the ball is off seat.

13. The production tubing pressure insensitive wireline retrievable safety valve of claim 10, wherein the power spring is disposed within a gas chamber formed by the hydraulic chamber housing, intermediate power seal, spring housing, lower power seal, and nose cap housing.

14. The production tubing pressure insensitive wireline retrievable safety valve of claim 11, wherein the actuation pressure is not sensitive to production tubing pressure.

15. The production tubing pressure insensitive wireline retrievable safety valve of claim 11, wherein the actuation pressure is substantially lower than a production tubing pressure at a setting depth of the wireline retrievable safety valve.

16. The production tubing pressure insensitive wireline retrievable safety valve of claim 11, wherein the power spring disposed within a gas chamber is not exposed to production tubing pressure.

17. The production tubing pressure insensitive wireline retrievable safety valve of claim 11, wherein the power spring disposed within a gas chamber is not sensitive to production tubing pressure.

18. The production tubing pressure insensitive wireline retrievable safety valve of claim 11, wherein the power spring disposed within the gas chamber does not require nitrogen charging to uncompress at depth.

19. The production tubing pressure insensitive wireline retrievable safety valve of claim 10, wherein the upper power seal and the lower power seal seals an annulus surrounding the power piston are exposed to production tubing pressure.

20. The production tubing pressure insensitive wireline retrievable safety valve of claim 10, wherein the upper power seal and the lower power seal have a same diameter to cancel out wellbore pressure forces acting on the power piston.

21. The production tubing pressure insensitive wireline retrievable safety valve of claim 10, wherein the upper power seal, the intermediate power seal, and the lower power seal are not exposed to pressure reversals.

22. A method of providing a deep set production tubing pressure insensitive wireline retrievable safety valve in a failed tubing retrievable safety valve, or hydraulic landing nipple comprising:
running a hydraulic communication tool into the tubing retrievable safety valve;
communicating the tubing retrievable safety valve;
landing a production tubing pressure insensitive wireline retrievable safety valve within a no-go shoulder profile of the tubing retrievable safety valve, or hydraulic landing nipple;
locking the wireline retrievable safety valve to the tubing retrievable safety valve, or landing nipple; and
controlling an actuation pressure of the production tubing pressure insensitive wireline retrievable safety valve from the surface.

23. The method of claim 22, wherein the actuation pressure is not sensitive to production tubing pressure.

24. The method of claim 22, wherein the actuation pressure is substantially lower than a production tubing pressure at a setting depth of the wireline retrievable safety valve.

25. The method of claim 22, wherein a power spring disposed within a gas chamber below a ball valve is not exposed to production tubing pressure.

26. The method of claim 22, wherein a power spring disposed within a gas chamber below a ball valve does not require nitrogen charging to uncompress at depth.

27. The method of claim 22, wherein an upper power seal and a lower power seal seals an annulus surrounding a power piston are exposed to production tubing pressure.

28. The method of claim 22, wherein an upper power seal and a lower power seal have a same diameter to cancel out wellbore pressure forces acting on a power piston.

29. The method of claim 22, wherein an upper power seal, an intermediate power seal, and a lower power seal are not exposed to pressure reversals.

30. A production tubing pressure insensitive gas vent valve comprising:
a hydraulic fluid intake port to receive hydraulic fluid from a surface, wherein the hydraulic fluid is communicated via at least one hydraulic fluid passage to a piston shoulder chamber disposed below the hydraulic seal to move a power piston under actuation pressure and compress a power spring disposed within a gas chamber;
a ball valve disposed above the hydraulic chamber and connected to the power piston that moves a ball off seat when the power piston moves down; and
at least one flow port that allow fluid communication from an annulus surrounding a portion of the gas vent valve into a central lumen of the gas vent valve exposed when the ball is off seat.
